(19) United States
(12) Patent Application Publication
(10) Pub. No.: US 2007/0099466 A1
(43) Pub. Date: May 3, 2007

(54) Information processing apparatus and electronic device system

(75) Inventor: Hajime Gushiken, Fussa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/585,188

(22) Filed: Oct. 24, 2006

(30) Foreign Application Priority Data
Oct. 31, 2005 (JP) 2005-317742

(51) Int. Cl. H01R 29/00

(52) U.S. Cl. 439/188

(57) ABSTRACT

According to one embodiment, an information processing apparatus includes a body, and a connector provided in the body and including a power receiving terminal and a contact for a data communication interface, the connector exclusively be connected to a first plug and the second plug, the first plug having a first power feeding electrode connectable to the power receiving terminal, and the second plug having a second power feeding electrode connectable to the power receiving terminal and a signal terminal connectable to the contact.

### CROSS-REFERENCE TO RELATED APPLICATIONS

This application is based upon and claims the benefit of priority from the Japanese Patent Application No. 2005-317742, filed Oct. 31, 2005, the entire contents of which are incorporated herein by reference.

### BACKGROUND

1. Field

One embodiment of the invention relates to an information processing apparatus and an electronic device system having a contact for data communication interface, which can be driven by the power supplied from the outside.

2. Description of the Related Art

When a notebook computer is used indoors, generally an external power supplied through an AC adaptor is used. At the same time, a USB mouse may be used by connecting to a USB connector provided in the computer.

In this case, the AC adaptor and the USB mouse have to be individually connected to the computer, which is troublesome.

Jpn. Pat. Appln. KOKAI Publication No. 2000-201204 discloses a cell phone which is driven by the secondary battery charged by using the DC output supplied from a USB terminal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of the structure of a notebook-sized personal computer and a relay adaptor (electronic device) having a USB hub function and an AC adaptor function, as the information processing apparatus according to one embodiment of the invention;

FIG. 2 is an exemplary view showing the structure of a connector provided in a computer side and a plug provided in a cable side;

FIG. 3 is an exemplary view showing the plug having an ordinary power feeding electrode only;

FIG. 4 is an exemplary block diagram showing the system structure of a computer and a relay adaptor;

FIG. 5 is an exemplary block diagram showing the system structure of the computer and the relay adaptor;

FIG. 6 is an exemplary view showing the connector having a terminal for transmitting DVI;

FIG. 7 is an exemplary perspective view showing one example of the structure of the notebook-sized personal computer, the relay adaptor, and the external display as an information processing apparatus according to one embodiment of the invention;

FIG. 8 is an exemplary block diagram showing the system structure of the computer and the relay adaptor; and

FIG. 9 is an exemplary block diagram showing the structure of the relay adaptor having a power communication function.

### DETAILED DESCRIPTION

Various embodiments according to the invention will be described hereinafter with reference to the accompanying drawings. In general, according to one embodiment of the invention, an information processing apparatus includes a body, and a connector provided in the body and including a power receiving terminal and a contact for a data communication interface, the connector exclusively be connected to a first plug and the second plug, the first plug having a first power feeding electrode connectable to the power receiving terminal, and the second plug having a second power feeding electrode connectable to the power receiving terminal and a signal terminal connectable to the contact.

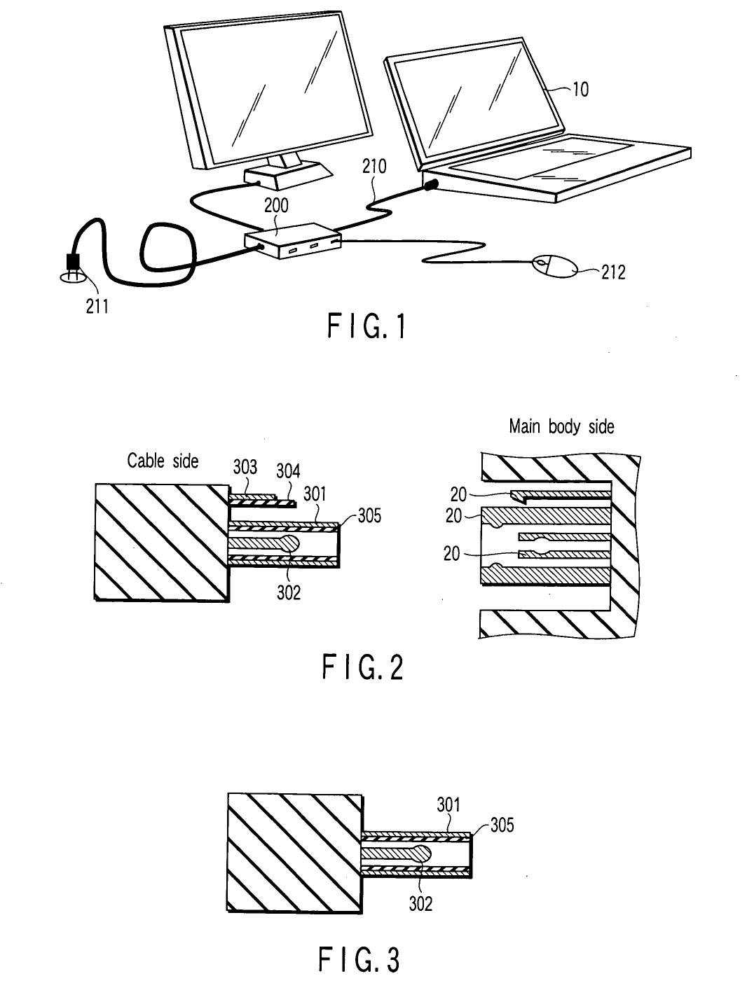

FIG. 1 is a perspective view showing one example of the structure of a notebook-sized personal computer and a relay adaptor (electronic device) having a USB hub function and an AC adaptor function as the information processing apparatus according to the embodiment of the invention.

The computer 10 is connected to the relay adaptor 200 through one cable 210. This cable includes a DC power line for supplying power to the computer and a USB line for connecting the computer to a USB hub function. Generally, two cables are required: one for supplying a DC power to a computer and the other for connecting the computer to the USB hub. The system of this embodiment, however, has only one cable to do both DC power supply and USB signal transmission.

A power plug 211 is connected to an AC outlet (power line receptacle), to supply the AC power to the relay adaptor 200. A USB mouse 212 is also connected to the relay adaptor 200.

The structure of a connector provided in the side of a computer 10 and a plug provided in the side of the cable 210 will be described referring to FIG. 2. The plug (second plug) of the cable 210 has a cylindrical ground electrode 301, a power feeding electrode 302, and a USB signal pin 303 as a signal terminal. The USB signal pin 303 is provided two terminals for DataNegative and for DataPositive.

The power feeding electrode 302 is provided inside the cylindrical ground electrode 301. The end face of the power feeding electrode 302 is inside the end face of the ground electrode 301. The USB signal pin 303 is provided outside the cylindrical ground electrode 301. The end face of the USB signal pin 303 is inside the end face of the power feeding electrode 302.

The connector of the computer has a ground terminal 312 to be connected to the ground electrode 301, a power receiving terminal 311 to be connected to the power feeding electrode 302, and a USB signal contact 313 to be connected to the USB signal pin 303.

When the plug is put into the computer 10, first the ground electrode 301 is connected to the ground terminal 312, then the power feeding electrode 302 is connected to the power receiving terminal 311, and finally the USB signal pin 303 is connected to the USB signal contact 313. Thus, connections are established in this order, hence to stabilize the operation of the computer.

It is also possible to insert a plug (first plug) having only the ordinal power feeding electrode 302 with no USB signal pin, as illustrated in FIG. 3, into the connector of the computer side.

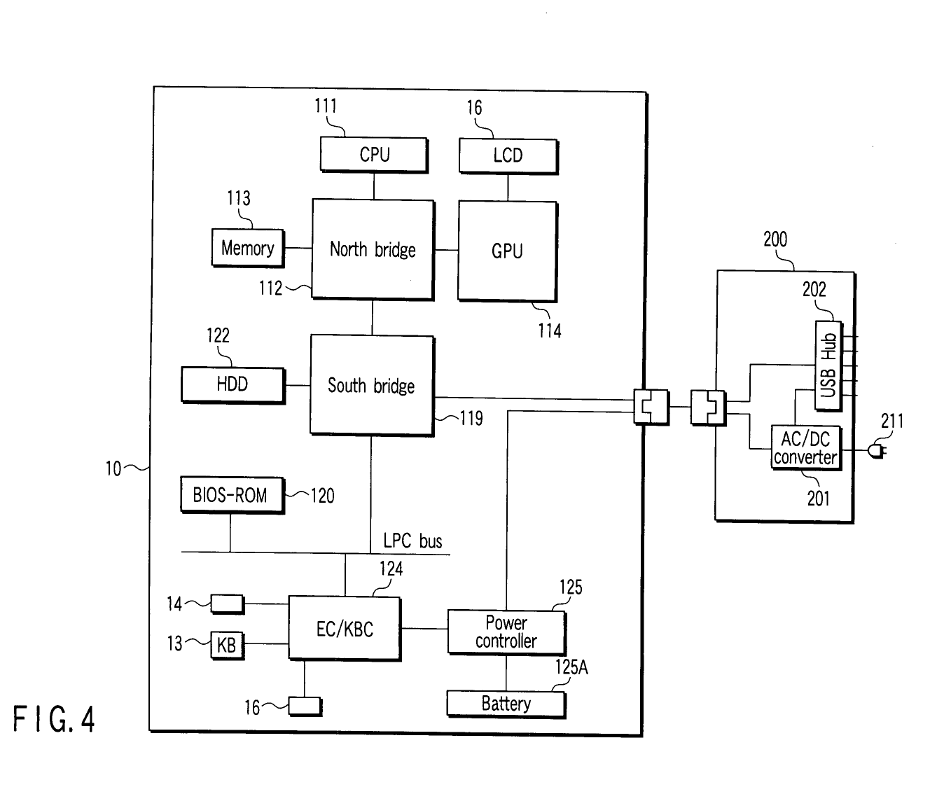

This time, the system structure of the computer 10 and the relay adaptor 200 will be described referring to FIG. 4.

As illustrated in FIG. 3, the computer includes a CPU 111, a north bridge 112, a main memory 113, a GPU (Graphics Processing Unit) 114, a south bridge 119, a BIOS-ROM 120, a hard disk drive (HDD) 122, an embedded controller/keyboard controller IC (EC/KBC) 124, and the like.

The CPU 111 is a processor provided in order to control the operation of this computer 10, running the operating system (OS) and various application programs loaded from the hard disk drive 122 to the main memory 113.

The CPU 111 also executes the BIOS (Basic Input output system) program stored in the BIOS-ROM 120. The BIOS-ROM 120 is a program for controlling the hardware.

The north bridge 112 is a bridge device which connects the local bus of the CPU 111 to the south bridge 119. The north bridge 112 incorporates a memory controller which access-controls the main memory 113. It also has a function of conducting communications with the GPU 114 through the AGP (Accelerated Graphics port) bus.

The GPU 114 is a display controller which controls a LCD 17 used as a display monitor of this computer 10. This GPU 114 has a video memory (VRAM), and produces video signals forming display images to be displayed on the LCD 17 of the display unit 12, from the display data written in the video memory by the OS/application programs.

The south bridge 119 controls the respective devices on a LPC (Low Pin Count) bus. It incorporates an IDE (Integrated Drive Electronics) controller, a PCI (Peripheral Component Interconnect) controller, and a USB controller so as to control the hard disk drive (HDD) 122.

The embedded controller/keyboard controller IC (EC/KBC) 124 is a one-chip microcomputer into which an embedded controller for managing the power and a keyboard controller for controlling a keyboard (KB) 13 and a touch pad 16 are integrated. This embedded controller/keyboard controller IC (EC/KBC) 124 has a power on/off function of turning the computer 10 on/off in cooperation with a power controller 125 according to a user's operation of a power button 14.

The power controller 125 produces a system power to be supplied to each component of the computer 10, using the external power (DC power) supplied from the relay adaptor 200. It also produces a system power to be supplied to each component of the computer 10, using an incorporated battery 125A of this controller.

The relay adaptor 200 has an AC/DC converter 201 which converts the AC voltage entered from the power plug 211 into the DC voltage (Direct Current signal). The D/C voltage converted by the AC/DC converter 201 is supplied to the USB hub 202 as the communication unit and also to the computer 10 as the external power.

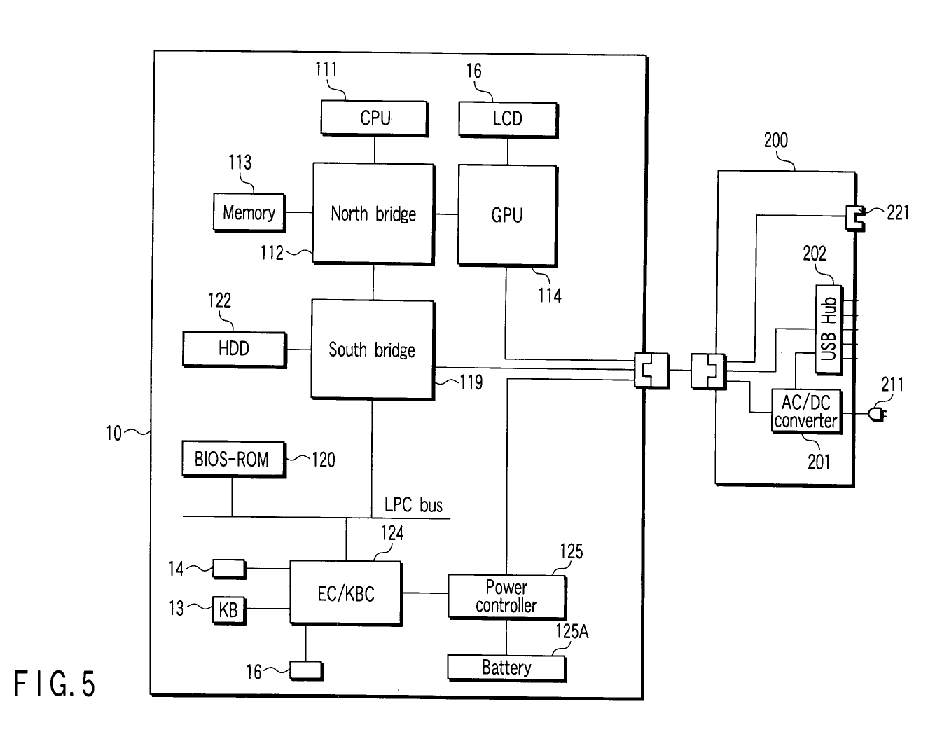

A contact to the DVI interface may be provided within the connector so that one cable can transmit the USB data, supply the external power to the computer 10, and transmit the video signals to it. In this case, as illustrated in FIG. 5, the GPU 114 can supply the video signals to the connector and the relay adaptor 200 has to be provided with a DVI connector 221.

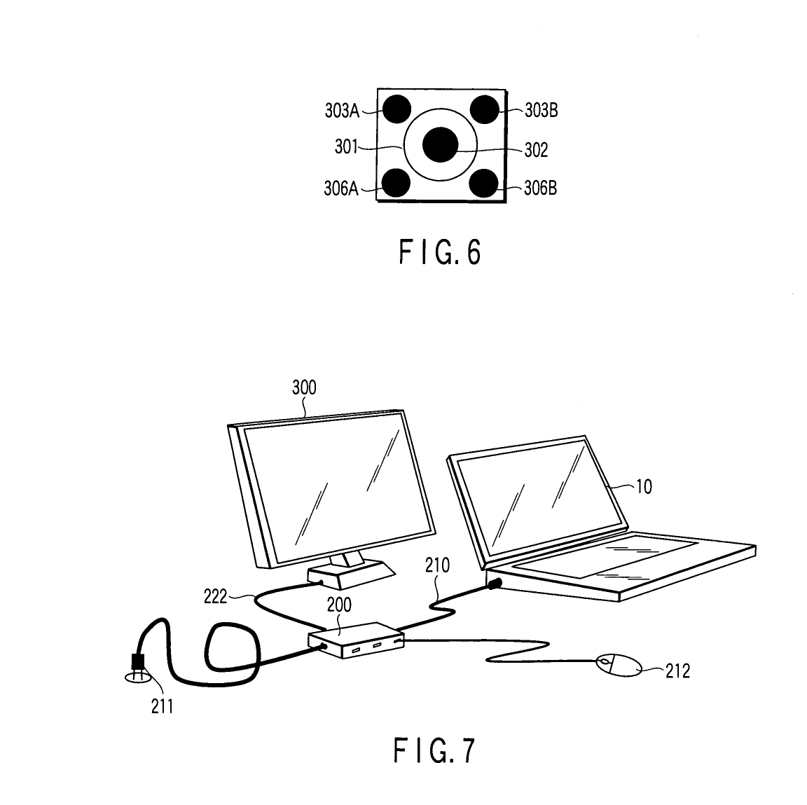

For example, as illustrated in FIG. 6, the connector of the computer is provided with the power feeding terminal 311, two signal contacts 313A and 313B for USB Data Negative and USB Data Positive, and two second contacts 316A and 316B for video signal transmission according to the DVI standard. Although the video signals according to the DVI standard need a three-channel data link connection and a six-channel data link connection depending on the display area of the corresponding display, this embodiment uses a channel of parallel-to-serial converted signals so as to realize a 3/6 channel data link connection by one or two lines.

As illustrated in FIG. 7, this structure enables the DVI cable 222 to connect the external display 300 and the relay adaptor 200, hence to route the cables neatly.

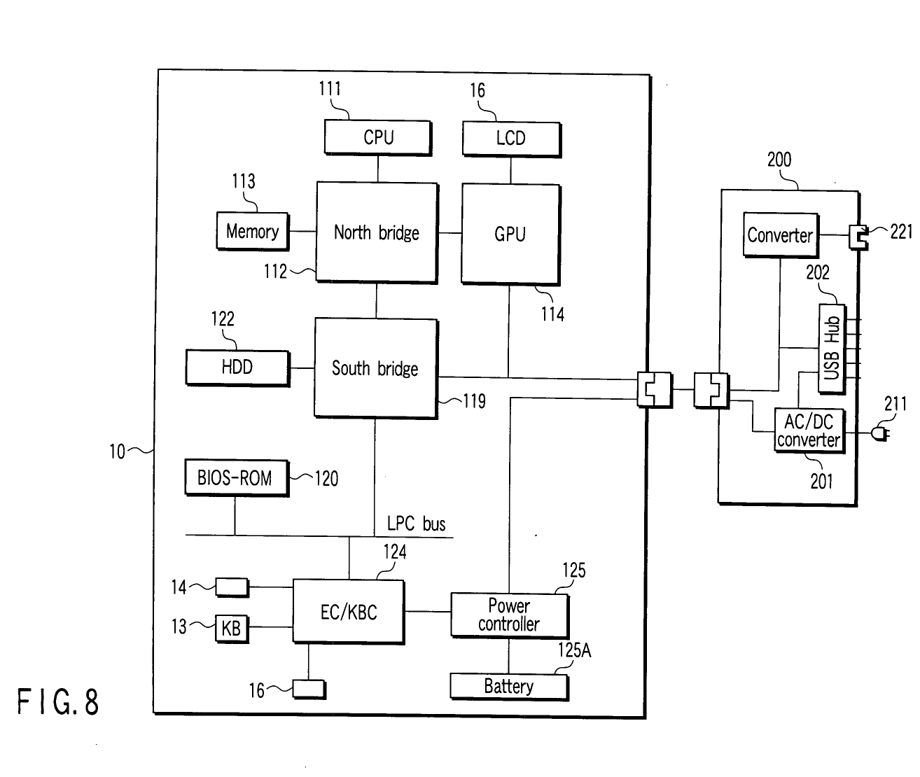

When the communication speed of the USB interface speeds up, the video signals can be transmitted by using the USB I/F. In this case, as illustrated in FIG. 8, the computer 10 is provided with a converter 150 for converting the video signals in order to transit the same signals through the USB. Further, the relay adaptor 200 is provided with the connector 221 of the DVI interface for video signal transmission and a converter 203 which converts the USB signals into the DVI transmission signals.

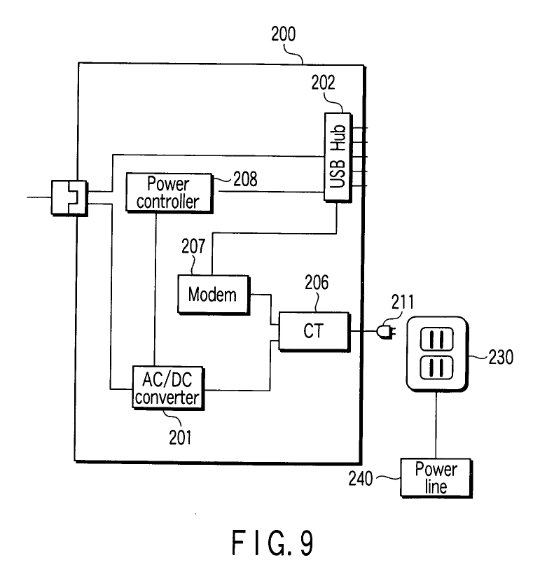

A modem of power line communication may be provided within the relay adaptor and the computer 10 may be connected to a network by using the USB interface. The structure with the power line communication modem provided within the relay adaptor is shown in FIG. 9.

As illustrated in FIG. 9, the power plug 211 is connected to the AC outlet (power line receptacle) 230 and connected to the power line 240 in the house. A coupler (CT) 206 has a function of dividing the signals supplied from the power plug 211 into the high frequency component and the alternating current component of the power. The high frequency component is supplied to the modem 207 and the alternating current component is supplied to the AC/DC converter 201. The coupler 206 has a function of supplying the signals output from the modem 207 to the power line 240 through the power plug 211.

The modem 207 has a function of converting the signals supplied from the coupler 206 into the signals in accordance with the physical layer/MAC (Medium Access Control) layer defined in the USB standard and a function of converting the signals supplied from the computer 10 into the signals in accordance with the physical layer/MAC layer of the power line communication. The power controller 208 controls the current amount supplied to the USB hub.

The computer 10 can be started and returned from a suspended state by the USB device side connected to the relay adaptor.

According to the above-mentioned system, since only one cable has to be connected for external power supply and connection taking along a USB device, the connection work becomes easy and in the transition from the mobile state to the AC adaptor connecting environment, a plurality of connectors don't have to be connected to the system, hence to improve the user's convenience.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a body; and
a connector provided in the body and including a power receiving terminal and a contact for a data communication interface, the connector exclusively be connected to a first plug and the second plug, the first plug having a first power feeding electrode connectable to the power receiving terminal, and the second plug having a second power feeding electrode connectable to the power receiving terminal and a signal terminal connectable to the contact.

2. The information processing apparatus according to claim 1, wherein
the connector is constituted such that after the power receiving terminal is connected to the second power feeding electrode, the contact is connected to the signal terminal.

3. The information processing apparatus according to claim 1, further comprising a video controller configured to produce video signals and supply the produced video signals to the contact.

4. The information processing apparatus according to claim 1, further comprising:
a video controller which generates video signals; and
a second contact to supply the video signals generated by the video controller, the second contact being included in the connector.

5. An electronic device system comprising:
a information processing apparatus which comprises a body, and a connector provided in the body and including a power receiving terminal and a contact for a data communication interface, the connector exclusively be connected to a first plug and the second plug, the first plug having a first power feeding electrode connectable to the power receiving terminal, and the second plug having a second power feeding electrode connectable to the power receiving terminal and a signal terminal connectable to the contact, and a electronic device connected to the information processing apparatus, which comprises a power feeding unit connected to the information processing apparatus through a cable having the second plug, the power feeding unit supplying an external power to the information processing apparatus through the cable, and a communication unit which executes data communication corresponding to the data communication interface through the cable.

6. The electronic device system according to claim 5, wherein
the connector is constituted such that after the power receiving terminal is connected to the second power feeding electrode, the contact is connected to the signal terminal.

7. The electronic device system according to claim 5, wherein
the information processing apparatus further comprises a video controller configured to produce video signals and supply the produced video signals to the contact.

8. The electronic device system according to claim 5, wherein
the information processing apparatus further comprises a video controller which produces video signals, and a second contact to output the video signals produced by the video controller, the second contact being included in the connector.
